(19) United States
(12) Patent Application Publication
(10) Pub. No.: US 2014/0304099 A1
(43) Pub. Date: Oct. 9, 2014

(54) METHOD AND APPARATUS TO FACILITATE PROPERTY LEASING

(71) Applicant: Property Connect, Inc., San Francisco, CA (US)

(72) Inventor: Timothy Kevin Manson, San Francisco, CA (US)

(73) Assignee: Property Connect, Inc., San Francisco, CA (US)

(21) Appl. No.: 14/245,782

(22) Filed: Apr. 4, 2014

Related U.S. Application Data
(60) Provisional application No. 61/809,186, filed on Apr. 5, 2013.

(51) Int. Cl. G06Q 30/06; G06Q 30/08

(52) U.S. Cl. CPC G06Q 30/0645; G06Q 30/08
USPC 705/26.3

(57) ABSTRACT

Methods and apparatus are described to facilitate the leasing of property, including the posting of properties to be leased, accepting bids from applicants, and mediating an auction process. The method and apparatus accepts multiple criteria bids, such as a rent, lease term, and move in date, and ranks the offers provided by applicants. Alternatively, or in addition, the method and apparatus includes the ability for the owner to set terms which may be accepted without competitive bidding among applicants. The method and apparatus also include the ability to provide applicants with feedback on the ranking of their bid.

### CROSS-REFERENCE TO RELATED APPLICATIONS

This application claims the benefit of U.S. Provisional Application No. 61/809,186, filed Apr. 5, 2013, the contents of which are hereby incorporated by reference in its entirety.

### BACKGROUND OF THE INVENTION

1. Field of the Invention

The present invention generally relates to the leasing of property, and more particularly to a method and apparatus for facilitating the leasing of property.

2. Discussion of the Background

Finding potential tenants to lease properties is an inefficient, time-consuming and expensive process for both the property owner and tenant. Both must spend significant time and energy in the process. Thus potential tenants may spend countless hours/days searching for an appropriate property. The owner must advertise to ensure that qualified tenants are aware of the property, and may spend numerous hours meeting and negotiating with potential tenants that are unable to afford, or are otherwise unqualified to rent or lease, a specific rental property.

In addition, current methods are not economically efficient, in that those methods do not facilitate the owner receiving the best offer for a property. This inefficiency is due to the limited number or potential tenants and the resulting inability of the process to identify a market value for the property.

While automated or partially automated systems for leasing property exist, these all have problems that result in an inefficient process.

Thus there is a need in the art for a method and apparatus that permits property owners to quickly find tenants for their properties. Such methods should be easy to use for the owner (or the owner's authorized representative) and applicants and should allow the owner to get market values for their property.

### BRIEF SUMMARY OF THE INVENTION

The present invention overcomes the disadvantages of prior art by providing a method and apparatus for gathering and presenting offers to a property owner, or an owner's authorized representative, to select a tenant for a commercial or residential property.

Various embodiments of the present invention provides solutions to problems with the prior art, including:

Providing a platform where owners can post property and where applicants can place offers in way that determines the market price for property;

Providing a cloud based Property Management System (PMS) that can interface to the application and credit check process, provides a portal for all correspondence and transactions regarding the property, and which allows tenants and owners to log in at any time to access the most up to date accurate information about the property;

Providing an efficient tenant application process with an inline application that can be used for applying for multiple properties, and which may include application scoring, status tracking, tenant history, and reviews and references;

Improving the efficiency interactions with the property owner or the property owner's authorized representative by automating advertising, application, and back office processing, and which provides a transparent market rent every time.

Embodiments of the present invention include systems and methods that facilitate the leasing of property. By way of example, embodiments are presented herein wherein a property owner may list properties for lease using computer-based methods, and where an applicant may view the listing and place bids to obtain a lease of the property. Various embodiments provide a level of transparency and ease of use that do not exist in current systems.

In certain embodiments, systems or methods of the present invention may be accessed by the property owner, or by the property owner's authorized representative which may be, for example and without limitation, an agent, manager, or landlord. The term “owner” as used herein may, unless otherwise stated herein, refer, without limitation to the property owner's authorized representative, and thus is understood to refer to the owner, or for example and without limitation, an agent, manager, or landlord for the owner. Certain embodiments may not differentiate between the owner and the owner's authorized representative. Certain other embodiments may, for example, have specific or different actions or screens specific to, for example, real estate agents, or to landlords. In general, the owner may list properties for lease, where the listing includes preferred and/or acceptable criteria of certain lease terms.

In other embodiments, systems or methods of the present invention may be accessed by a prospective tenant, who may review listings and may apply for listed properties. The prospective tenant is also referred to herein as an “applicant.” One or more applicants may bid on listed properties. The methods or systems of the present invention facilitate awarding the lease by competitive bid or, in certain circumstances, by providing the owner with a bid that the owner has agreed to be acceptable, before the bidding begins, for immediate acceptance.

Certain embodiments provide a method for leasing property using a computing system having a server. The method includes the steps of: providing preferred values for at least two lease criteria to the server; accepting bids from one or more applicants, where each bid includes a bid value for each of the at least two lease criteria, and were the accepting includes providing the bid values for storage on a server; receiving a ranking of the one or more applicants based on the preferred values and the bid values accepted for each applicant; and awarding a lease to the acceptable applicant based on the received ranking.

Certain other embodiments provide an apparatus for leasing property. The apparatus includes a server programmed to: accept preferred values for at least two lease criteria; accept bids from one or more applicants, where each bid includes a bid value for each of the at least two lease criteria; provide a ranking of the one or more applicants based on the preferred values and the bid values accepted for each applicant on a display; and award a lease to the acceptable applicant based on the ranking.

Certain embodiments provide a method for leasing property using a computing system having a server. The method includes the step of: accepting bids from one or more applicants including a first applicant and one or more additional applicants, where each bid includes a bid value for each of the at least two lease criteria, where each of the at least two lease criteria has a preferred value, and were the accepting includes providing the bid values for storage on a server; determining a ranking of the one or more applicants based on the preferred values and the bid values accepted for each of the one or more applicants; and providing the first applicant with an indication of the ranking of the first applicant.

Certain other embodiments provide an apparatus for leasing property. The apparatus includes a server programmed to: accept bids from one or more applicants including a first applicant and one or more additional applicants, where each bid includes a bid value for each of the at least two lease criteria, where each of the at least two lease criteria has a preferred value; determine a ranking of the one or more applicants based on the preferred values and the bid values accepted for each of the one or more applicants; and provide the first applicant with an indication of the ranking of the first applicant on a display.

Certain embodiments provide a method for using a computing system having a server to allow an applicant to determine their ranking prior to submitting a bid for leasing property. The method includes the steps of: accepting a proposed bid from a first applicant and a submitted bid from a second applicant, where the proposed bid and the submitted bid each include a bid value for each of the at least two lease criteria, where each of the at least two lease criteria has a preferred value, and were the accepting includes providing the proposed bid and the submitted bid for storage on a server; determining a ranking of the first applicant based on the proposed bid of the first applicant and the submitted bid of the second applicant; and providing the first applicant with an indication of the ranking of the first applicant.

Certain other embodiments provide an apparatus to allow an applicant for a property to determine their ranking prior to submitting a bid for leasing property. The apparatus includes a server programmed to: accept a proposed bid from a first applicant and a submitted bid from a second applicant, where the proposed bid and the submitted bid each include a bid value for each of the at least two lease criteria, where each of the at least two lease criteria has a preferred value; determine a ranking of the first applicant based on the proposed bid of the first applicant and the submitted bid of the second applicant; and provide the first applicant with an indication of the ranking of the first applicant on a display.

These features together with the various ancillary provisions and features which will become apparent to those skilled in the art from the following detailed description, are attained by the method for facilitating leasing of property of the present invention, preferred embodiments thereof being shown with reference to the accompanying drawings, by way of example only, wherein:

### BRIEF DESCRIPTION OF THE SEVERAL VIEWS OF THE DRAWING

FIGS. 1 and 2 are illustrative schematics of one embodiment of a platform of the present invention as a system including a server for providing programming instructions to one or more devices over a network;

FIGS. 3A, 3B, and 3C is a flowchart illustrating the workflow of the invention as used by the property owner;

FIGS. 4.1 through 4.17 illustrate screen shots that the platform may provide on a display to a property owner so that they may input information about property to be leased, including a property description and preferred lease terms;

FIGS. 5A and 5B is a flowchart illustrating the workflow of the invention as used by the an applicant; and

FIGS. 6.1A, 6.1B, 6.1C, 6.2, 6.3, 6.4 and 6.5 illustrate screen shots that the platform may provide to an applicant to enable them to view and place offers on properties;

The following description includes Figures having reference symbols to indicate certain components, aspects or features shown therein, with reference symbols common to more than one Figure indicating like components, aspects or features shown therein.

### DETAILED DESCRIPTION OF THE INVENTION

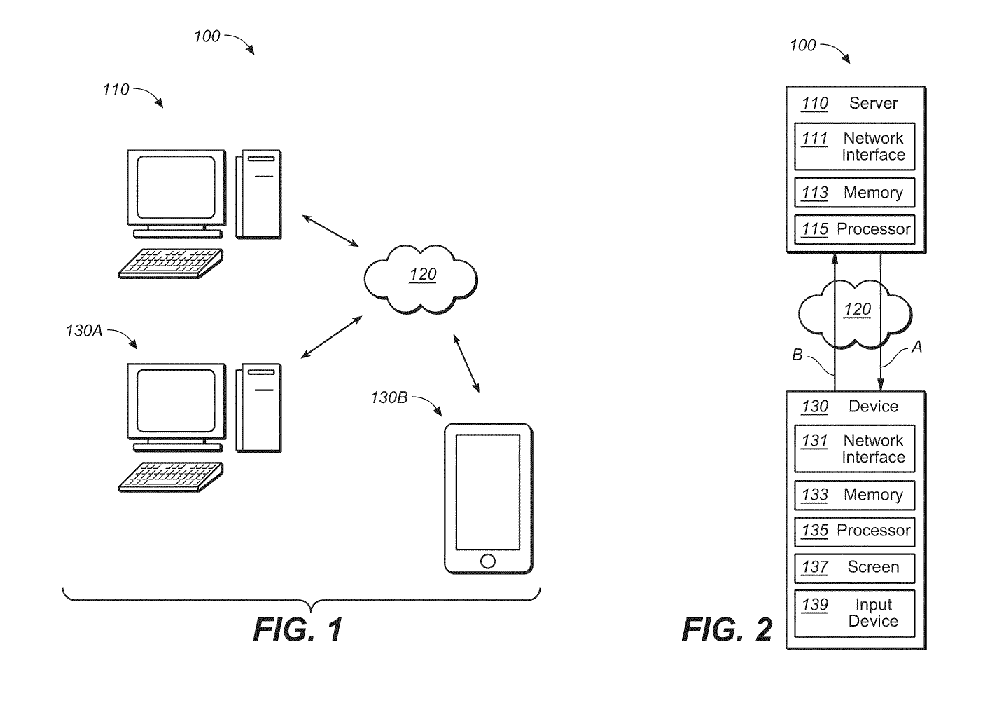

FIGS. 1 and 2 are illustrative schematics of one embodiment of a platform of the present invention as a system 100 including a server 110 for providing programming instructions to one or more devices 130 (shown, without limitation as a device 130A and a device 130B) over a network 120. In one embodiment, devices 130 are wireless devices, and network 120 includes wireless communication to the device. In general, server 110 may produce programming instructions, files, or data that may be transmitted over network 120 to operate devices 130.

In general, a user of device 130 may communicate over network 120 to server 110, which includes programming to receive and transmit information with devices 130. FIG. 2 illustrates one embodiment of platform 100 programmed as a system of the present invention.

Server 110 is a computer or computer system that includes a network interface 111, a memory 113, and a processor 115. Is to be understood that network interface 111, memory 113, and processor 115 are configured such that a program stored in the memory may be executed by the processor to accept input and/or provide output through network interface 111 over network 120 to devices 130.

Devices 130 may be, for example and without limitation, a desktop or portable computer (shown schematically as device 130A), or a cellular telephone, tablet computer, or a portable digital assistant (shown schematically as device 130B), and includes a network interface 131, a memory 133, a processor 135, a display 137, and an input device 139. Network interface 131 is used by device 130 to communication over a wireless network, such as a cellular telephone network, a WiFi network or a WiMax network, and then to other telephones through a public switched telephone network (PSTN) or to a satellite, or over the Internet. Memory 133 includes programming required to operate device 130 (such as an operating system or virtual machine instructions), and may include portions that store information or programming instructions obtained over network interface 131, or that are input by the user (such as telephone numbers or images from a device camera (not shown). In one embodiment display 137 is a touch screen, providing the functions of the screen and input device 139.

One use of platform 100 for facilitating the leasing of property will now be described. In general, there are two types of users of platform 100—applicants and owners. Thus, for example, memory 113 and or 133 is provided with software that enables owners to find tenants to lease property.

### Owner Use of the Inventive Platform

In one embodiment, an owner may log on to device 130A, for example, and provide profile information regarding property to be leased. Platform 100 uses the input provided by an owner for a property and then posts the property as being for lease for some period of time. During this time, the owner, through system 100, may entertain bids on the property from applicants.

Typically, the owner lists requirements for offers which, at a minimum, may include but is not limited to as rent, lease term, and move-in date. In addition the owner may consider one or more of the following in awarding the bid: security deposit, upfront payment, credit score, income, verification of income, employment, verification of employment, references and endorsements, either professional or personal, past rental history, information on, or the presence of, additional/independent guarantors, or co sign—co lessees, background check—including criminal, bank statement verification and bank statement balance. The owner may review the offers and accept one, or none, of the offers.

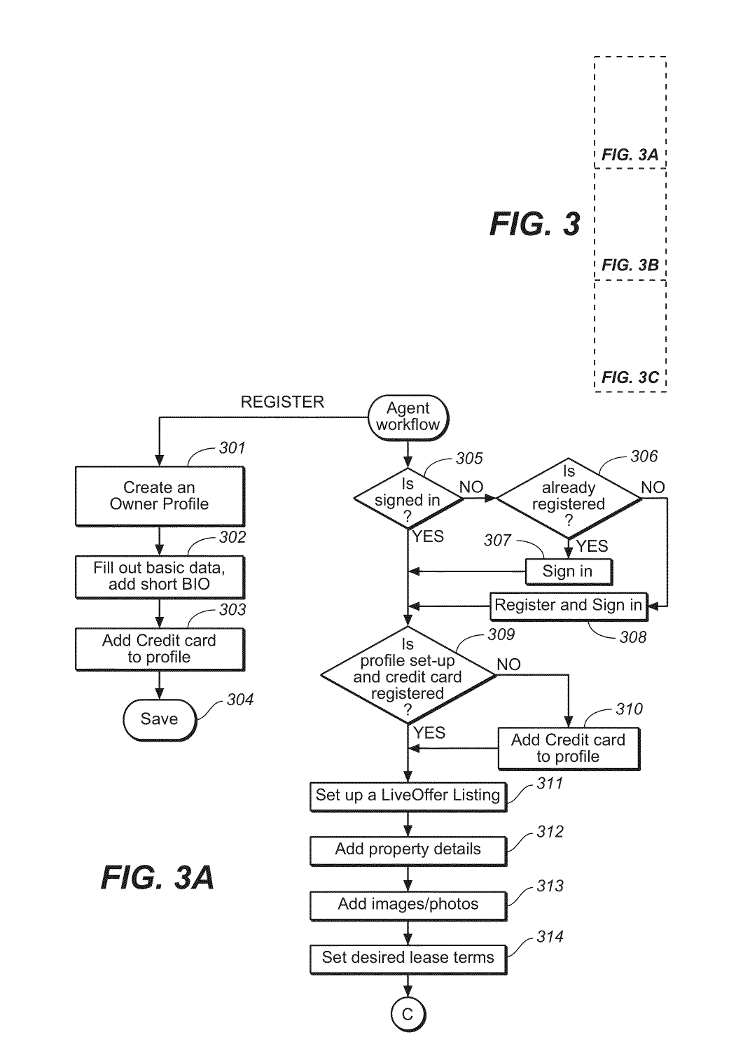

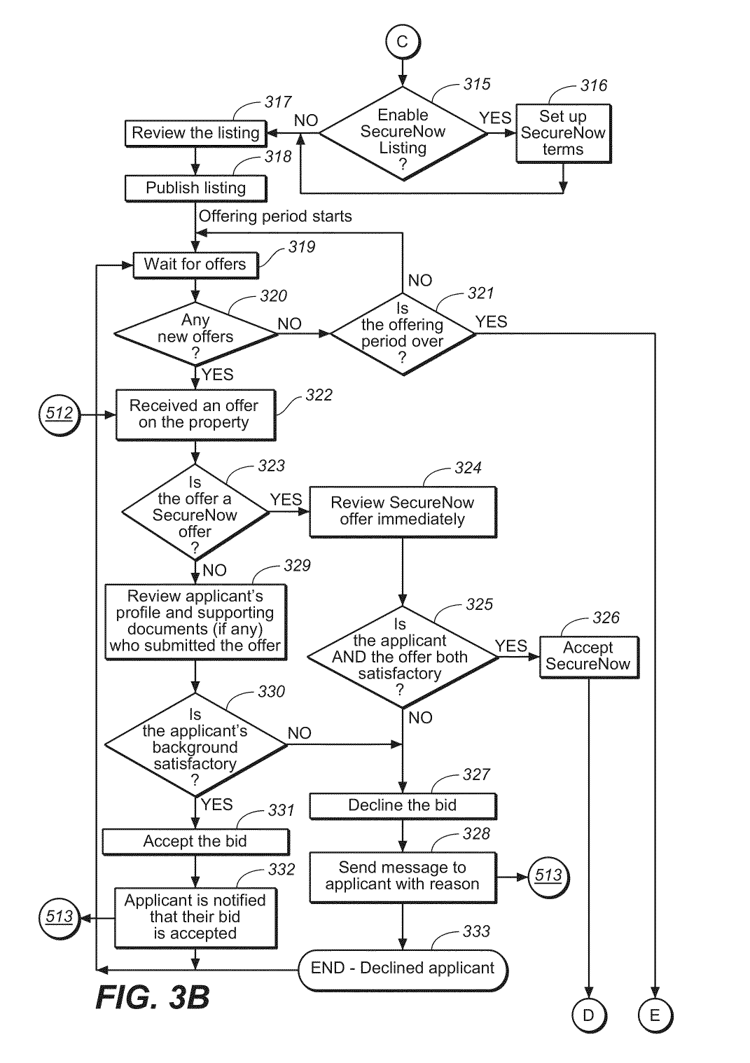

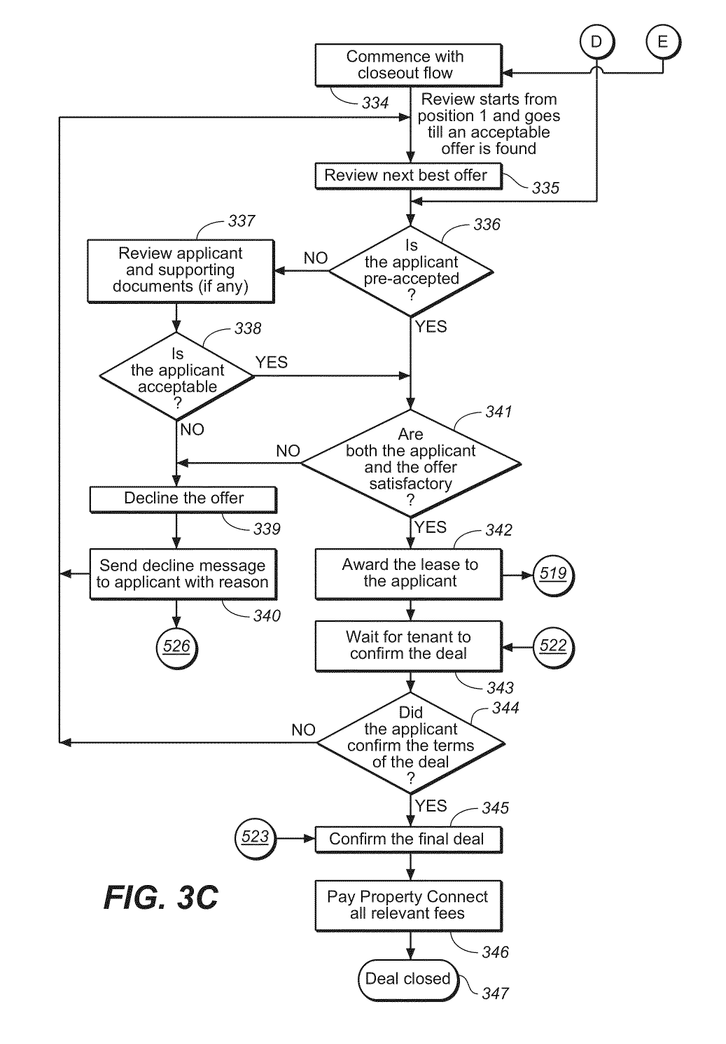

FIGS. 3A, 3B, and 3C is a flowchart 300 illustrating one embodiment of the workflow of the invention as executed on platform 100 and as used by an owner, and specifically operations performed by the owner on device 130A or 130B in conjunction with the programming of server 110 of platform 100. In general, flowchart 300 illustrates how an owner may set auction to determine which applicant may be awarded a lease.

Blocks 301, 302, 303, and 304 illustrate the steps of platform 100 for the registration of an owner. Thus, for example, the owner registers by providing owner/manager information (Block 301), provides basic data and biographical information (Block 302), provides credit card information (Block 303), and then saves the owner profile (Block 304).

Blocks 305 through 347 illustrate the steps of platform 100 for entering property information and managing bids on properties.

Blocks 305, 306, 307, and 308 illustrate the steps for owner signing into the system, including determining if the owner is currently signed on to system 100 (in Block 305), and if not, determining if the owner is registered (Block 306), and then either prompting the owner to sign in (Block 307) or to register the owner (as in Blocks 301, 302, 303, and 304), and then signing in the owner (Block 308).

In Blocks 309 and 310, system 100 checks that the owner's profile is set up and the owner's credit card is registered Next, the owner provides platform 100 with information for providing a new listing or modifying the listing of a property, including notifying system 100 that a listing is to be set up or modified (Block 311), adding property details (Block 312), adding image or photos (Block 313), and setting a desired lease terms (Block 314). As described subsequently, lease terms, which are also referred to herein as lease criteria, may include, but are not limited to, a rent (such as, for example and without limitation, an amount per night, per week, or per month), a move-in date, a security deposit, and lease term. In addition, the owner may place upper and/or lower limits on any of the terms. The limits may be presented to applicants and/or may be used by the owner to evaluate bids.

In one embodiment, bids are evaluated and ranked against one another to determine a “best” bid. The competitive bid process is also referred to herein, without limitation, as “LiveBid,” operates using the terms added in Block 314.

In another embodiment, the owner may specify criteria values that will cause the owner to immediately determine if the applicant is acceptable and award the bid without competitively bidding. This type of bid is referred to herein, without limitation, as a “SecureNow” bid. In yet another embodiment, the system may accept both types of bids—that is, competitive bids are accepted until a bidder meets the SecureNow terms.

In Block 315, the owner informs platform 100 if they wish to enable applicants to place SecureNow bids. If so, then the owner is prompted to provide SecureNow terms (Block 316). In certain embodiments, SecureNow terms may also include a required upfront payment that may be, for example and without limitation, some integral amount of rent. Thus, for example, the owner may require that an applicant provide an upfront payment of 1 months' rent, or a number greater than one month's rent, such as 2 months' rent, 3 months' rent.

Next, the owner is given the opportunity to review the listing (Block 317), and then to publish the listing (Block 318). Once published, system 100 allows applicants to view and bid on the property.

The owner may also provide system 100 with an offering period, which may be, for example, a starting time and a stopping time for accepting bids (that is, competitive bids among applicants or SecureNow bids for instant acceptance). In alternative embodiments, the starting time is the time the listing is published. In another alternative embodiment, the stopping time is left open, and system 100 accepts bids until one has been accepted and finalized.

System 100 determines if bids are being accepted (that is, if the current time is within the offering period), and accepts bids during this time. In Blocks 319, 320, and 321, system 100 waits for offers as long at the offering period is not over by proceeding to wait for new offers (Block 320). If there are no new offers and the offering period is over, then the flow proceeds to commence with closeout flow (Block 334)

While in the offering period, system 100, in Block 320, new offers are received at Block 322. Block 323 determines if the offer is a “SecureNow” offer, and if not, the applicant's profile and documents are reviewed (Block 329).

If the applicant's background is satisfactory, as determined in Block 330, then the bid is accepted (Block 331), and the applicant is notified that the bid is accepted (Block 332), and the flow returns to Block 319 to await new offers. Criteria for determining if an applicant's background includes, but is not limited to evaluation of the applicant may include, but are not limited to, an evaluation by credit score, verified income, and/or a background check (such as a criminal check). The verification in Block 331 may be done by consideration of the owner, or may be performed automatically by system 100 or by some other computer-based system.

If the applicant's background is deemed to not be satisfactory (in Block 330), then the bid is declined (Block 327), and the applicant is notified (Block 328), the applicant is declined (Block 333), and the flow returns to block 319 to await new offers.

If Block 323 determines if the offer is a “SecureNow” offer, then the offer is reviewed (Block 324). If the applicant's background and the offer are satisfactory (as in Block 330), then the flow proceeds from Block 325 to Block 326, where the offer is accepted. Closeout of the SecureNow offer then occurs. In certain embodiments, the applicant's background is approved before the bidding process, and if the applicant is pre-accepted (Block 336), and if the applicant and offer are satisfactory (Block 341), then the lease is awarded to the applicant (Block 342). If the applicant confirms the deal (Block 343 and 344), then the deal is finalized (Block 345), the owner collects fees (Block 346), and the deal is closed (Block 347). If the applicant does not confirm the deal, then the next best offer is reviewed (Block 335) and the bid evaluation proceeds as described subsequently.

Closeout proceeds from Block 334, where the best offer among the completive (non-SecureNow bids) is determined in Block 335. Algorithms for ranking offers and determining a best offer are described subsequently. In certain embodiments, the ranking of offers is performed by comparing each offer with the preferred terms of the owner, and providing a numerical ranking. Such ranking may depend, but is not limited to, considerations of rent, term, security deposit, and move in date.

Blocks 336 through 343 cycle through the offers starting at the highest ranked offer, determining if certain other criteria are met, and then accepting the offer, or proceeding to the next highest ranked offer.

In Block 336, it is determined if the applicant is pre-accepted, according to their credit history, for example, for being awarded the lease. If not, the applicant's supporting documents are reviewed (in Block 337), and if acceptable, and if the offer is satisfactory (in Block 341), the lease is awarded to that applicant in Block 342. The applicant is notified of this and must confirm the award (in Block 343), and if son, the final deal is confirmed (in Block 345), the applicant's fees are paid to the owner (in Block 346), and the deal is closed (in Block 347).

If the applicant is not acceptable, as determine in Block 338, or if the applicant's offer is not satisfactory, as in Block 341, then the applicant's offer is declined (in Block 339), and the applicant is so notified (Block 340), and the system determines the next highest ranked bid (Block 335).

The result of flowchart 300 is to award the lease to either: 1) the first acceptable SecureNow bid, or 2) the most highly ranked and acceptable offer.

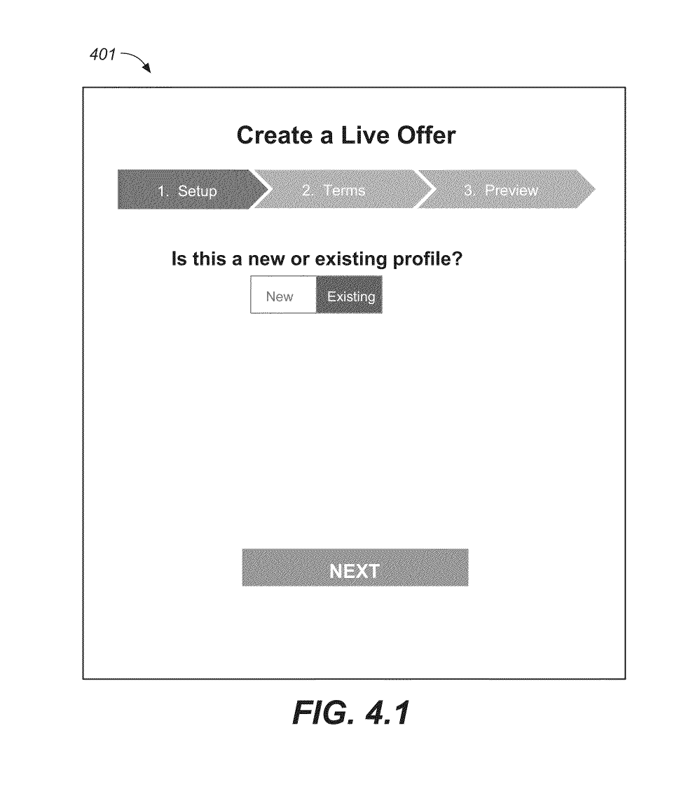

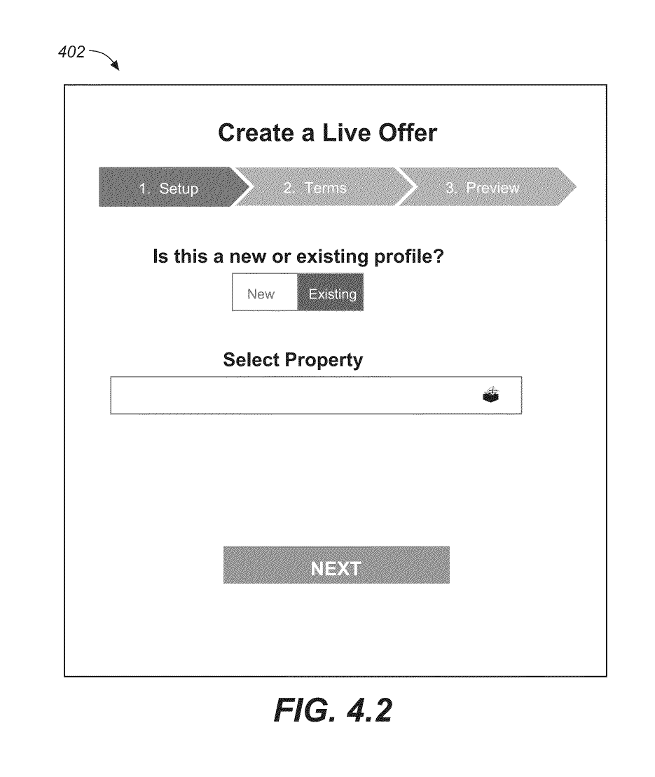

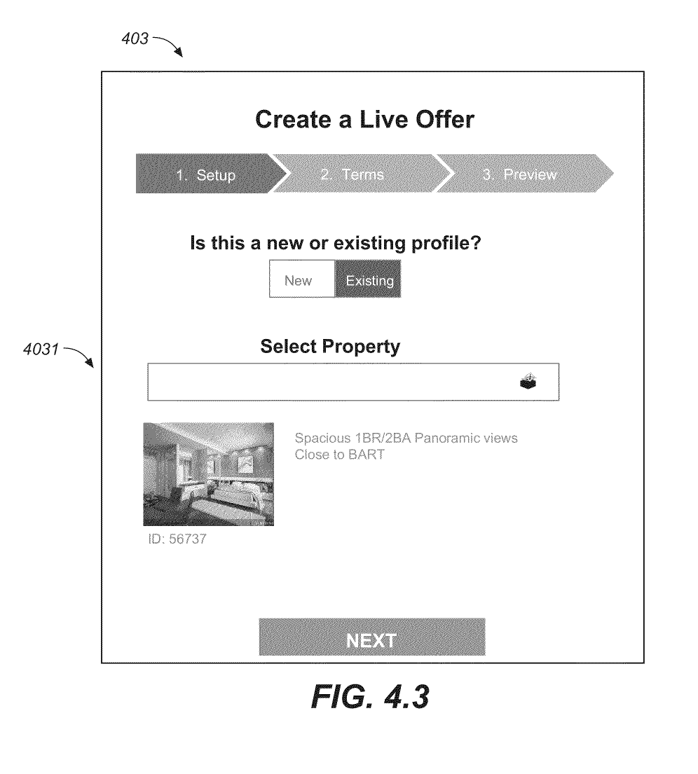

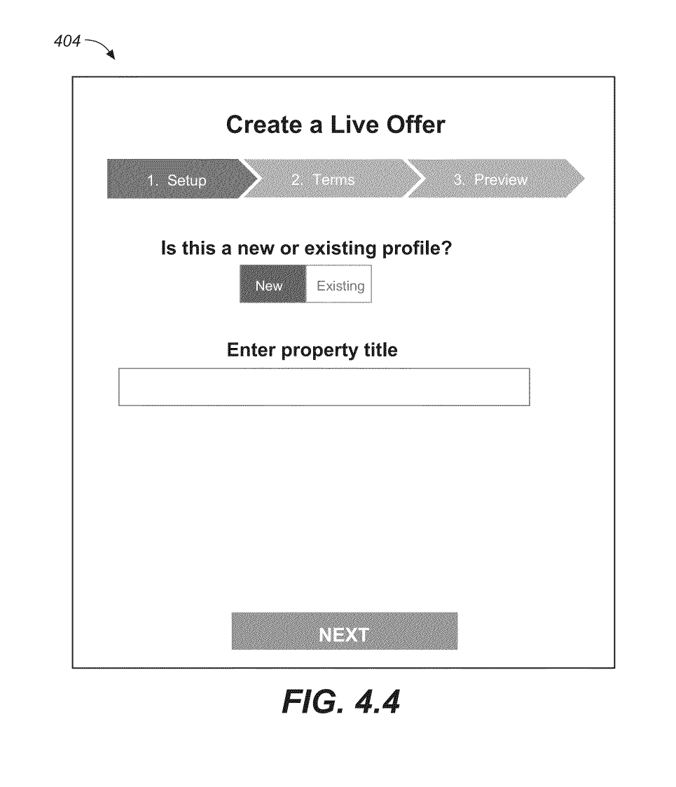

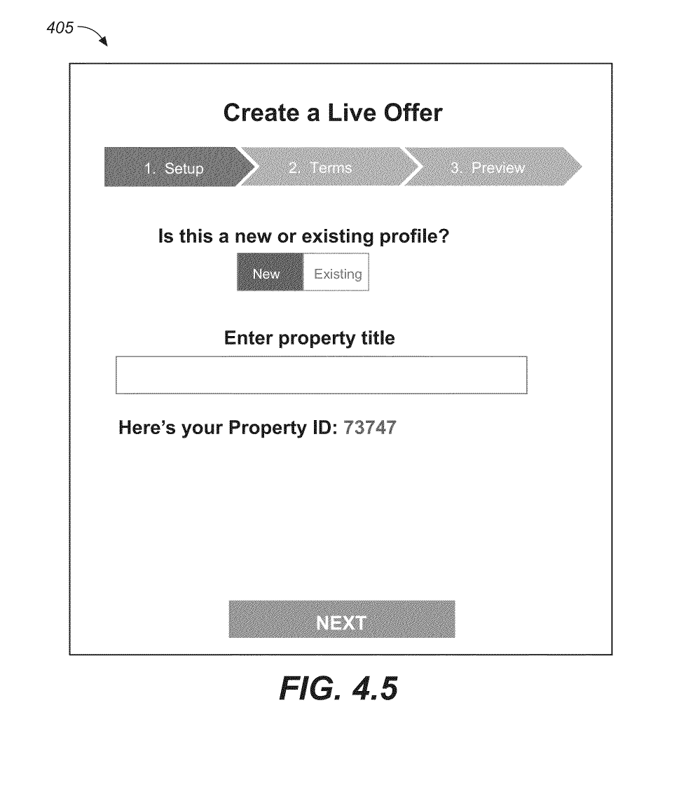

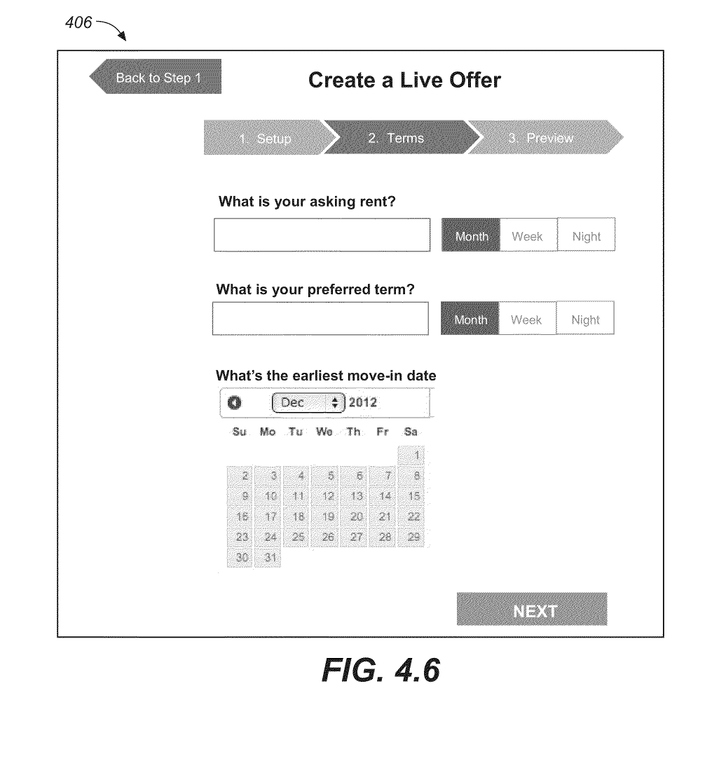

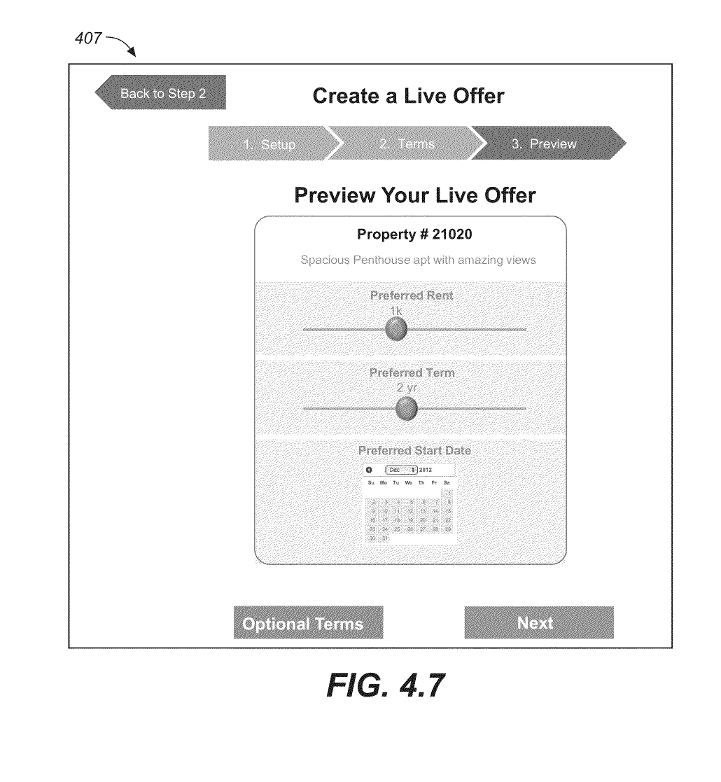

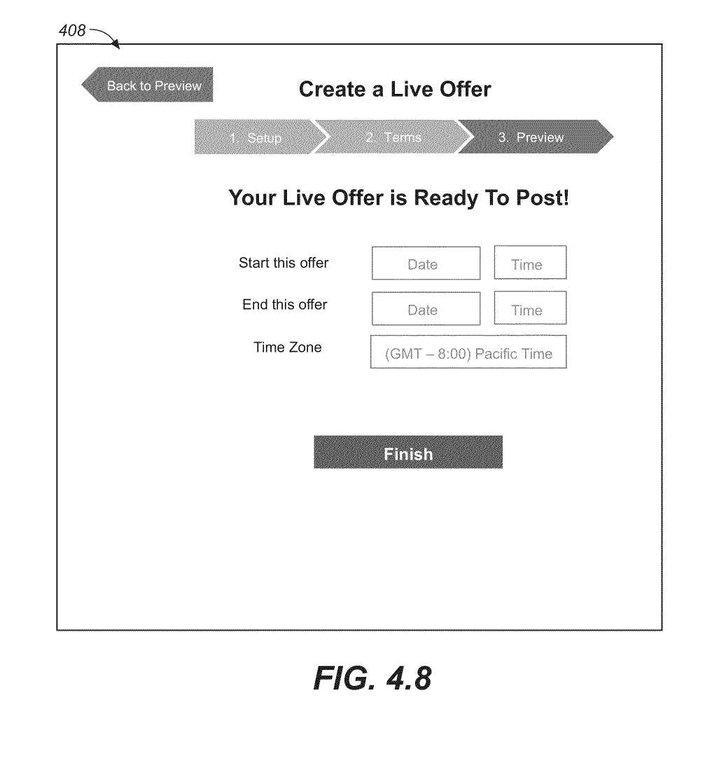

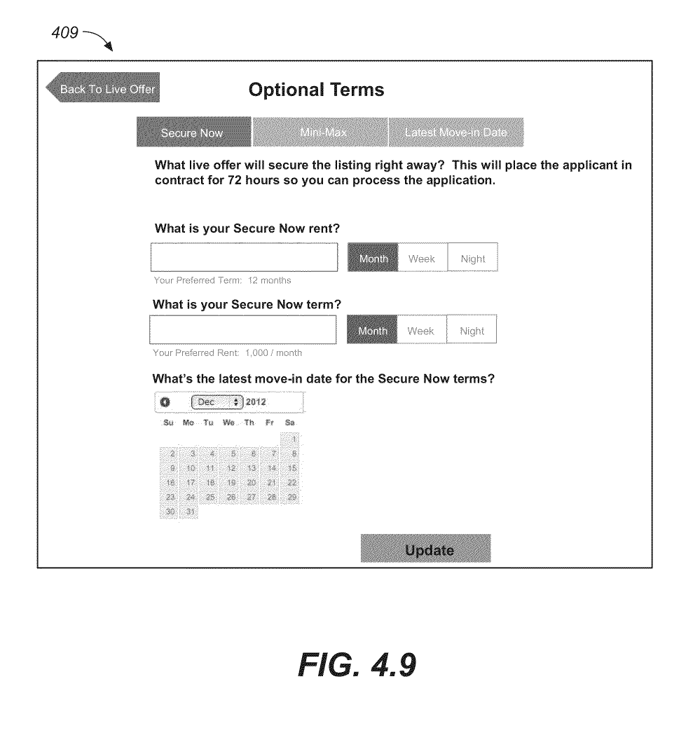

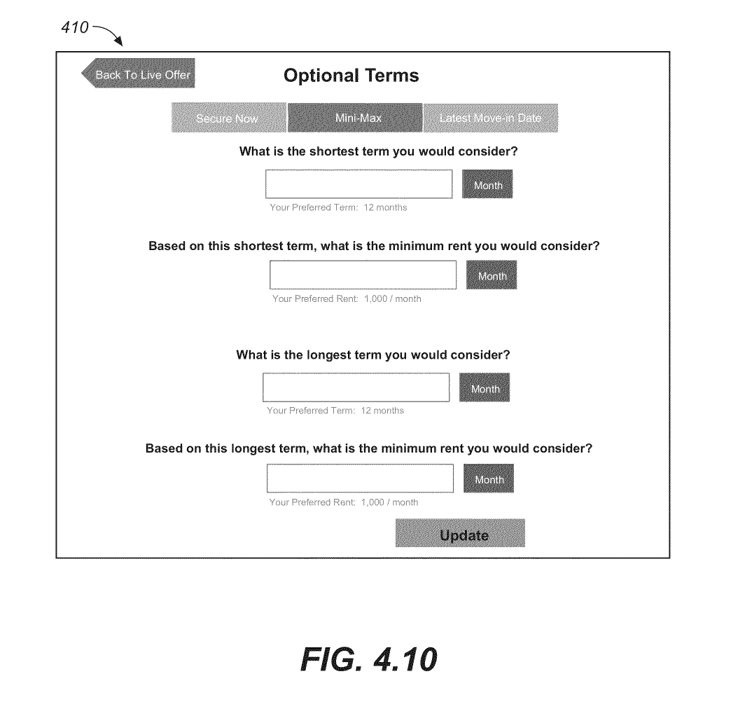

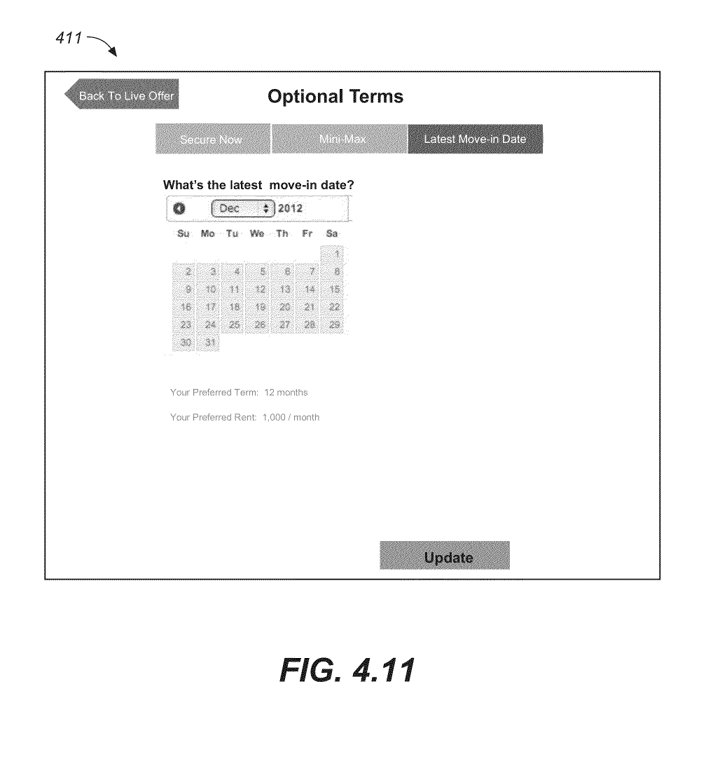

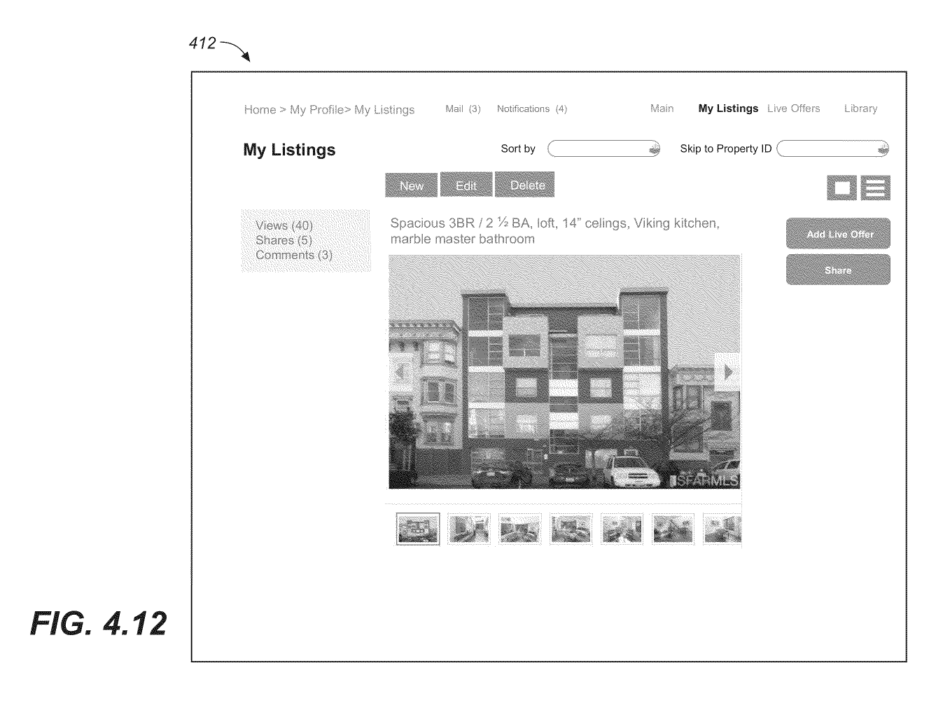

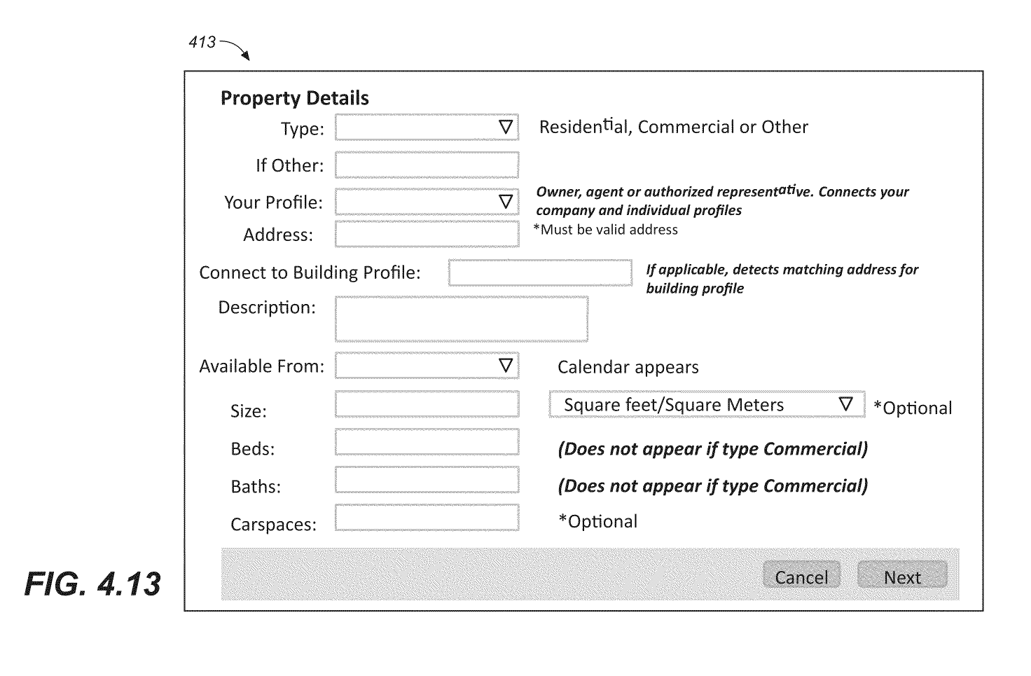

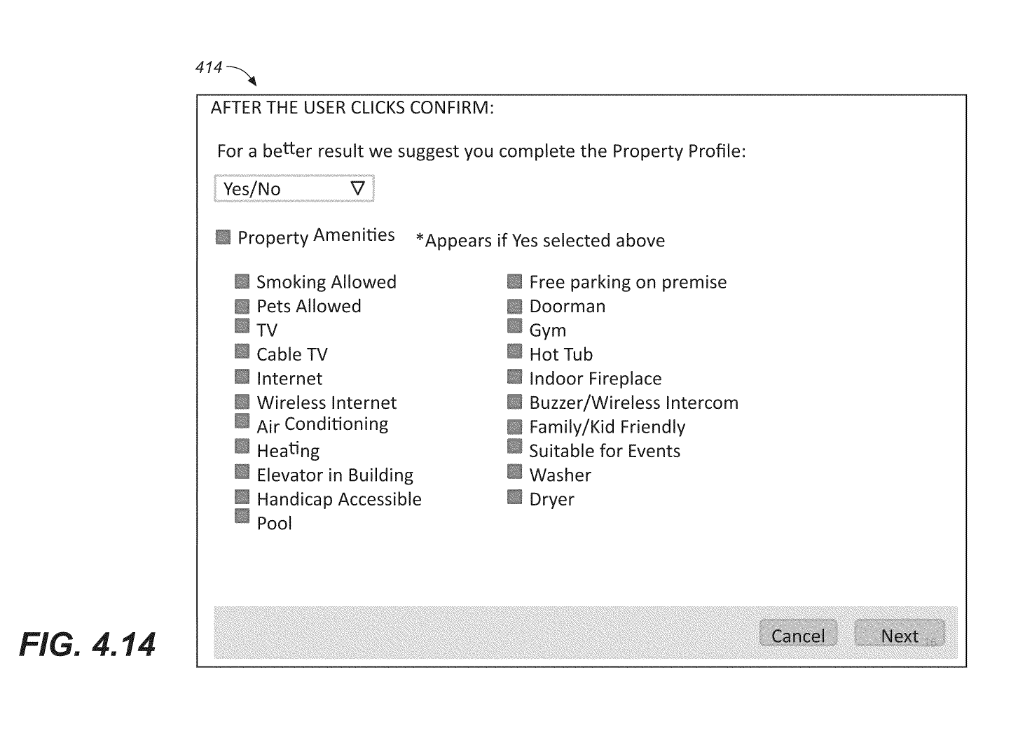

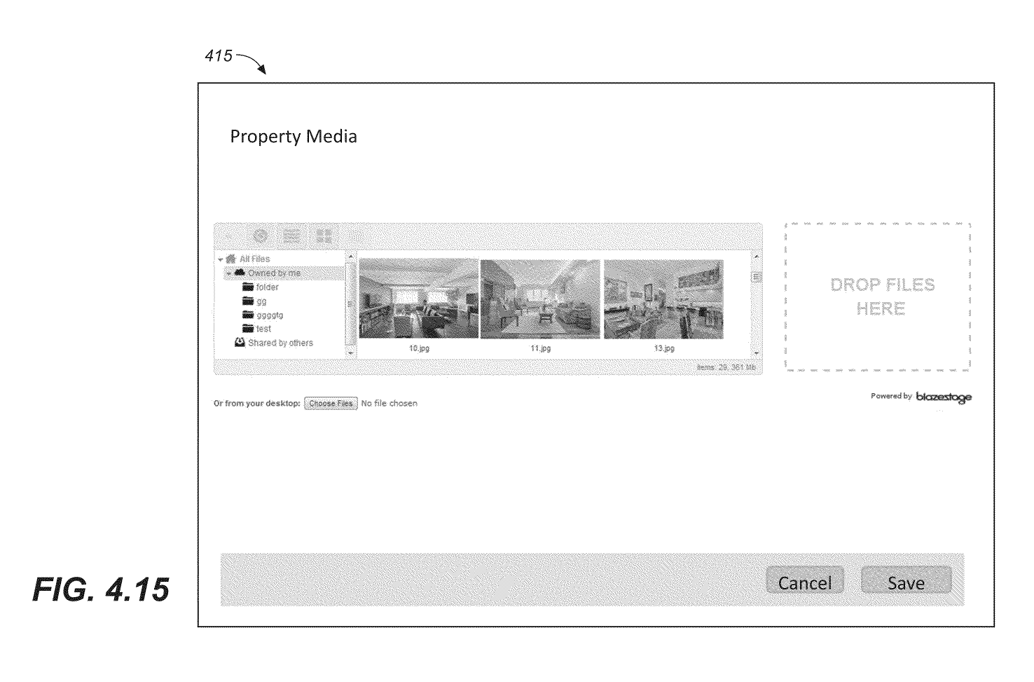

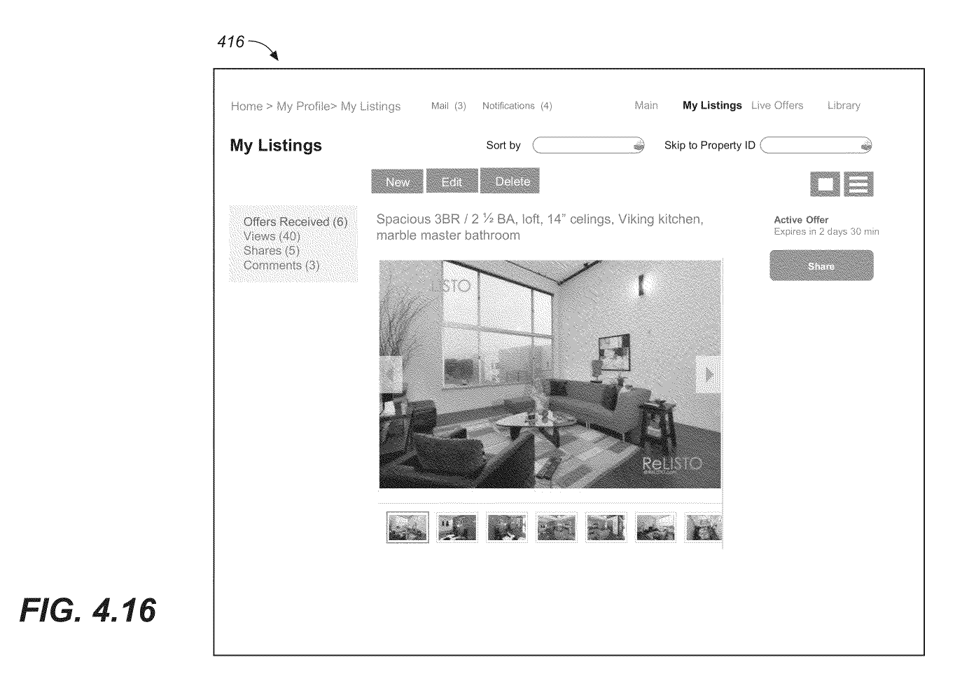

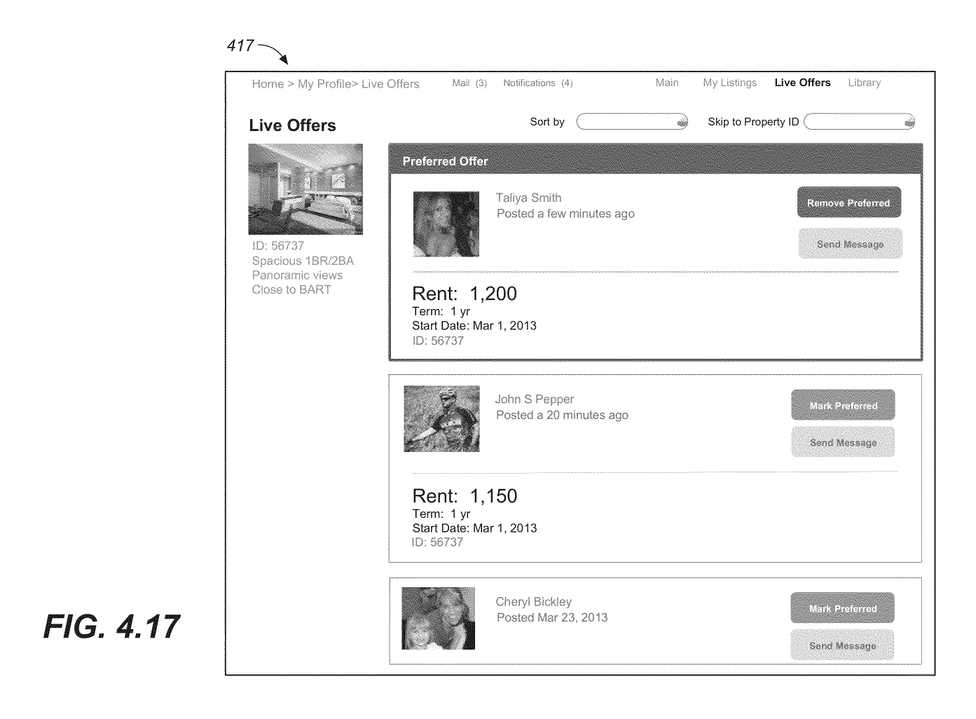

FIGS. 4.1 through 4.17 illustrate screen shots of one embodiment of the owner's use of system 100, which may be generally similar to that shown in flowchart 300. The screenshots are generated by platform 100, such as server 110, and may provide on display 137 to an owner so that they may input information about property to be leased, including a property description and preferred lease terms.

FIG. 4.1 shows a screen shot 401 which prompt an owner with “Is this a new or existing profile?” The response to this prompt may be input below the prompt as either “New,” meaning that the property to be leased has never before entered into platform 100, or “Existing,” meaning that the property has already been entered into platform 100. The owner may then select “Next” to identify the property.

If the input from FIG. 4.1 is “Existing,” then platform 100 retrieves previously stored property information as shown in FIGS. 4.2 and 4.3. Screen shot 402 of FIG. 4.2 displays a pull-down menu under “Select Property.” Platform 100 accesses a database on server 110 of properties previously entered by the owner, as shown in screen shot 403 of FIG. 4.3, which shows information on a property selected by the owner. An example of displayed property information is shown, for example and without limitation, in region 4031 of screen shot 403.

If the input from FIG. 4.1 is “New,” then platform 100 prompts the owner for information about the property as shown in the screen shot 404 of FIG. 4.4 and screen shot 405 of FIG. 4.5. In one embodiment, the minimum amount of information required to list a property is a property title. System 100 accepts the input of a Property Title, and assigns a unique Property ID as illustrated. System 100 stores the Property ID, property information, and owner information in memory 113. The Property ID may be provided, via e-mail, websites, or through social media, as a way of allowing an applicant to access the property description and place offers for the property.

The information which may be stored in memory 113 for each property includes a property identification number and some or all of the following: a title, property description, property amenities, photographs, videos, documents which may include but are not limited to plants, contracts, and renovation details.

After the property is identified by providing input to platform 100 from the screen shots 401, 402, 403, 404, and 405, the owner may be prompted for additional lease terms, as illustrated in screen shots 406 of FIG. 4.6, respectively, where the owner may be prompted for a rent (R_ask), term (T_ask), and move-in date (Date_ask).

Platform 100 then provides screen shot 407 of FIG. 4.7, which shows a preview of the information provided from FIGS. 4.1 through 4.7. In one embodiment some lease terms which an applicant may bid on are shown in slider (as in the rent and term). As shown in screen shot 407 the owner is prompted to continue (“Next”) or if optional terms are to be entered into the system (“Optional Terms”).

If the owner selects “Next” from screen shot 407, then screen shot 408 of FIG. 4.8 is displayed, which prompts the owner to provide data used for setting the offering period: specifically, by providing a start time and an end time for the offer, as used in Block 321, for example. The owner may then click on “Finish,” and platform 100 will provide the listing during the specified times. Alternatively, platform 100 may provide other screens that allow the owner to provide additional property information, including but not limited to, photographs, a more complete description, and a list of amenities.

If the owner selects “Optional Terms” from screen shot 407, then the screen shots 409, 410, and 411 of FIGS. 4.9 through 4.11, respectively, appear, prompting for information optional terms which are accessed by selecting tabs “Secure Now,” “Min-Max,” and “Latest Move-in Date.”

As discussed above, the “SecureNow” optional term indicates an offer that the owner will accept without resort to consideration of other offers (with reference, for example, to Block 316). As shown in screen shot 409, the owner is prompted, for example, for the following Secure Now criteria: a “Secure Now rent” (R_Secure), a “Secure Now term” (T_Secure) and “Latest Move-in Date” (Date_Secure), In addition, the SecureNow terms may include an upfront payment of rent. SecureNow criteria will be presented to all applicants. An applicant that submits the Secure Now criteria will be reported to the owner as having met the SecureNow criteria.

The “Min-Max,” and “Latest Move-in Date” optional terms allow for a more flexible offer generation process, by specifying criteria other than the asking criteria which would be acceptable to the owner.

The “Min-Max” optional term (screen shot 409) places pairs of acceptable criteria. Since there are several offer criteria, such as rent, term, and move-in date, certain embodiments of the present invention allow the owner to specific combinations of acceptable criteria. Thus, for example, while the starting requirements are acceptable terms for the lease, an owner may be willing to accept a higher rent for shorter term, or vice versa, or may be willing to accept a later move-in date with a higher rent.

Screen shot 410 illustrates that the owner may be prompted for two pair of term criteria. The first pair of criteria is a shortest term (T_min) and corresponding minimum rent for a lease at the shortest term (R_min). The second pair of criteria is a longest term (T_max) and corresponding minimum rent for a lease at the longest term (R_max). A minimum and/or maximum may apply to any terms that are being bid on.

The “Latest Move-in Date” optional term indicates the very latest move-in date that the owner will accept. As shown in screen shot 411 of FIG. 4.11, the owner may be prompted for the Latest Move-in Date.

FIG. 4.12 shows screen shots 412 which includes a view of the property that the owner may access with platform 100. In one embodiment, screen shot 412 is accessed directly from an owner sign-in page (not shown). In another embodiment, the owner is optionally directed to these pages when initially listing the property.

The information displayed in screen shot 412 is retrieved from memory 113 and may be accessible to the applicant, about individual properties, groups of properties (such as a building or other development), and about the owner or agent. From this page the owner may enter information about a new property, such as descriptions, photographs, amenities, edit the information about a property previously entered into platform 100, or delete a property. The owner may also click “Add Live Offer,” which causes platform 100 to display screens to prepare a listing for offer. The owner may also click “Share,” which prepares a submission to a social media cite or an e-mail including the property number.

FIGS. 4.13, 4.14, and 4.15 are illustrative screen shots 413, 414, and 415, respectively, and illustrate how an owner may input additional property information, screen shot 413 is an input screen for basic property information screen shot 414 is a screen input for property amenities, and screen shot 415 is an input screen for providing photographs of the property. Information so entered is stored on server 110.

Screen shot 416 of FIG. 4.16 is similar to screen shot 413 of FIG. 4.12, and appears when a property has active offers. The left side has regions that, when clicked on, allow the owner to view (not shown): Offers Received, who as Viewed the property, where the property has been shared, and any comments.

Screen shot 417 of FIG. 4.17 displays the offers provided by applicants for one specific property showing offers, which may include, for example and without limitation, all offers, all pending offers, or all approved offers, ranked as according to the ranking algorithm discussed subsequently. Display 137 shows each offer, the owner may review the offers and mark one them as a “preferred offer” and also send each applicant a message. In an alternative embodiment, platform 100 may analyze the offers and indicate a “preferred offer” based on some algorithm. Thus, for example and without limitation, platform 100 may execute an algorithm that ranks the offers by rent, by term, by upfront payment, by move-in date, or by some combination thereof. As one example of a sorting criterion, the offers are first ranked by rent, where the offer with the highest rent is most highly ranked. Next, if there are two or more offers for the same rent, those offers are ranked by term, where the offer with the longest term is most highly ranked. Lastly, if there are two or more offers for the same rent and term, those offers are ranked by move-in date, where the offer with the earliest move-in date is most highly ranked.

### Ranking Offers

In certain embodiments, platform 100 provides the owner with information about the offers, and the owner is responsible for ranking the offers as they arrive and selecting a winning offer. The owner may make a decision based on criteria other than the offers. As an example, the owner may decide that an applicant with a higher credit score is a better tenant that another offer including a higher rent or the owner may greatly prefer the earliest move-in date and gives that special consideration.

In certain other embodiments, platform 100 is programmed to sort offers by certain criteria and provide the owner with suggested best applicants. In one embodiments, the algorithm, which may, for example, be provided in Block 335, compares each applicants offer with preferred values provided by the owner. The details of the algorithm may depend on what a specific owner considers to be most important and may provide a score for each applicants offer to provide a numerical ranking of the offers. In one embodiment the bids are scored to reflect the time value of money for the owner.

In one embodiment, the owner may provide, for example and without limitation, one or more preferred lease criteria, such as a preferred rent, lease term, stay move in date, and upfront payment. An applicant may make an offer that may be the same or different than the owner preferences. This, for example, the applicant may offer a rent, move-in date, upfront payment, and term that differ from the owner's preference for each. An algorithm then calculates a score based on the owner's preferences and the applicants offer, and derives a numeric score that may be compared to other applicants.

In general, the algorithm used should reflect lease criteria that the owner considers to be important and return a numeric score that can be used to consider which of several bids is the “best.” Thus, for example, the owner may provide, as discussed previously, a preferred rent, term, move-in date, and upfront payment—that is, R_ask, T_ask, Date_ask, and Up_ask, respectively. As discussed subsequently, an applicant may provide a bid that includes their desired rent, term, move-in date, and upfront payment, referred to herein, for example, as R, T, Date, and Up, respectively. The algorithm may use R_ask, T_ask, Date_ask, Up_ask, R, T, Date, and Up to generate a numeric score. In general, the score may be represented as: Score=fn(R—R_ask), (T-T_ask), (Date-Date_ask), (Up-Up_ask)), where the function fn reflects the importance of the various parameters to determine a “best” bid. The score may further be normalized or otherwise manipulated to allow for a ranking of all bids.

In certain embodiments, the function, fn, may be a linear combination of the parameters, such as:

Score=f_{R}(R-R_ask)+f_{T}(T-T_ask)+f_{D}(Date-Date_ask)+f_{U}(UP-Up_ask), or

Score=f_{R}(R-R_ask)*f_{T}(T-T_ask)*f_{D}(Date-Date_ask)*f_{U}(Up-Up_ask),

where the functional forms of f_{R}, f_{T}, f_{D}, f_{U} reflect their importance and whether it is deemed more important for the bid, for example, the higher the rent, the better, or if it is more important for the bid value to accurately reflect an asking value, such as desiring a specific move-in date. The functional forms of f_{R}, f_{T}, f_{D}, f_{U} may be monotonic or may be symmetric about the asking value.

As examples of the various functional forms, for example and without limitation, the move in date and preferred term may be symmetric curves, such as (Date-Date_ask)2, or exp[−(T-T_ask)²], and the rent and the upfront payment may be monotonic, such as sqrt(abs(R-Rask)), or (Up-Up_ask)². In addition, the functional form may be discontinuous. For example, if the owner will only consider a move in date between the asking date and the end of month, the function may be of the form f_{D}(Dep-Dep_ask)=1 if Dep-Dep_ask>0 and Dep-Dep_ask<1 month, or is 0 otherwise.

In this way, each bid may be assigned a numerical score, with the highest score representing the “best” bid.

### Applicant's Use of the Inventive Platform

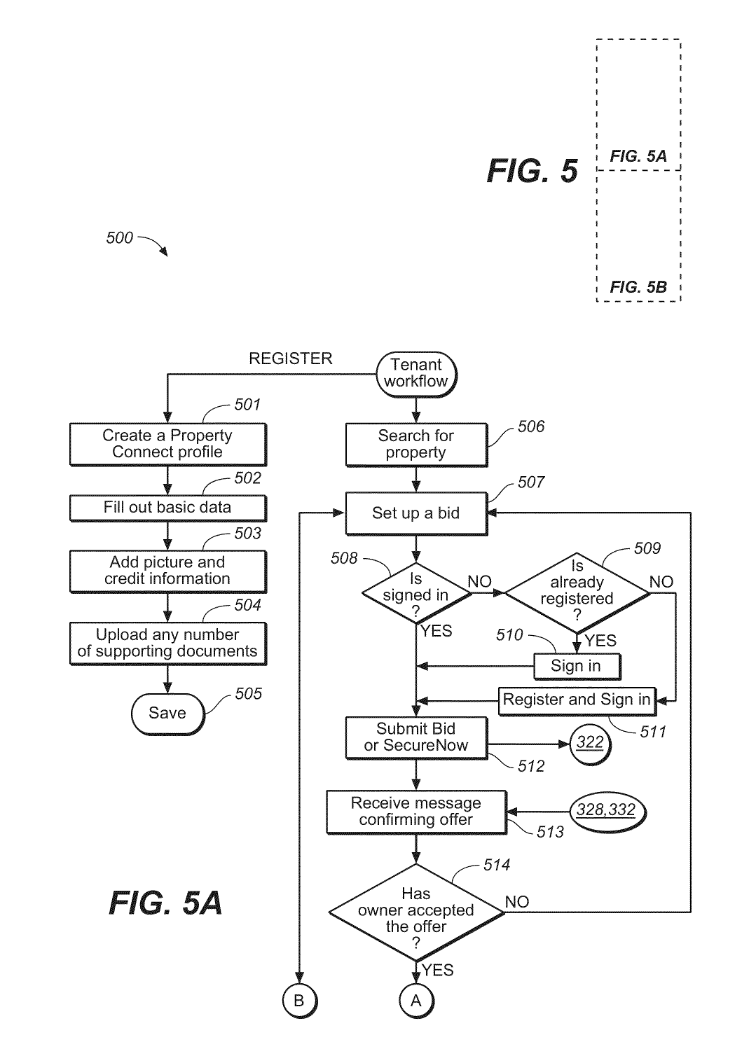

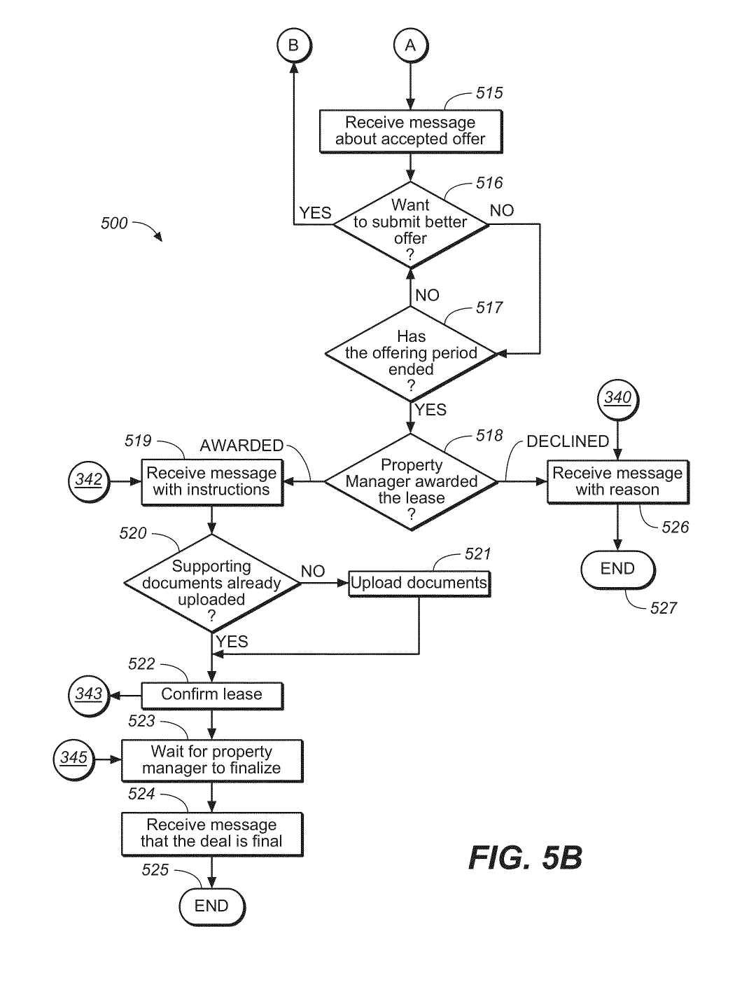

In one embodiment, an applicant may view and place offers on properties. FIGS. 5A and 5B is a flowchart 500 illustrating the workflow of the invention as executed on platform 100 and as used by applicants, and specifically operations performed by the applicants on device 130A or 130B in conjunction with the programming of server 110 of platform 100.

Blocks 501, 502, 503, 504 and 505 illustrate the steps of platform 100 for the registration of an applicant. Thus, for example, the applicant by creating a profile (Block 501) which may include providing a name and e-mail address, or by registering through a social networking site, providing some basic data (Block 510), which may include additional personal information or information regarding what type of property the applicant is looking for, adding a photograph and credit information (Block 503), and uploading supporting documents that might be needed to secure a lease (Block 504). The applicant is then sorted in system 100 (Block 505).

Flowchart 500 also illustrates actions taken by the applicant and system 100 in finding, bidding, and awarding leases. The applicant may begin by searching (Block 506) for property listed by owners on system 100. This searching may be by location, property size, rent, or any number of criteria stored in system 100.

Once the applicant finds a property that they are interested in, they may proceed to place an offer, as shown in Blocks 507 through 516. In Block 507 the applicant indicates that they wish to set up a bid.

Specifically, system 100 prompts the applicant for bid values. Thus, for example, some or all of the criteria (rent, move-in date, etc.) that the owner establishes as illustrated above maybe required input for the applicant. In certain embodiments, the minimum criteria required by the applicant in Block 507 are a bid values for rent, move-in date, upfront payment, and term. In some embodiments, system 100 may allow an applicant to enter any value for these criteria and evaluate them all in the ranking process, as discussed above. In other embodiments, system 100 may set absolute ranges and, for example, an applicant may not be allowed to place a bid to move in before or after some specific date, or to propose a rent less than some minimum value.

Blocks 508, 509, 510, and 511 assure system 100 that the applicant is registered and signed in, similar to the steps of Blocks 305 through 308 followed by the owner, as discussed above.

Next, in Block 512, the applicant informs system 100 which type of offer is to be made: an offer which will be ranked and judged against other applicants (as in Block 335), or an offer that meets criteria for immediate acceptance by system 100 (as for a SecureNow bid in Block 324). The bid criteria entered in Block 507 are then sent to the owner, as for example, to Block 322. System 100 then informs the applicant that the offer has been submitted (Block 513), though the screen used to place the offer or through e-mail or a text message, for example. The message received in Block 513 may be, for example, the messages referred in Block 328 or 332.

The steps of Block 514 may, for example, correspond to those of flowchart 300, where a SecureNow bid is accepted at Block 326, or a competitive offer is accepted at Block 342.

If the applicant's offer has not been accepted at Block 514, the applicant may set up another offer at Block 507. If the applicant's offer is accepted, then system 100 sends the applicant a message that the offer has been accepted at Block 515.

If the applicant's offer is accepted at Block 514, and if offers are still being accepted, that is, the time is still within the offer period, Blocks 516 and 517 allow the applicant to change their bid to be more competitive, returning flow back to Block 507.

At the end of the offering period, as determined at Block 517, the owner (or system 100) makes a decision to award the lease at block 518. If the applicant's offer is declined, the applicant is notified of this decision at Block 526, and the bid process for the applicant ends (Block 527).

If the owner (or system 100) awards the lease, the applicant is provided with a message and instructions to finalize the lease (Block 519). System 100 then checks to see if all supporting documents are uploaded (Block 520), and instructs the applicant to do so if they have not yet provided supporting documents (Block 521).

The lease is then confirmed (Block 522) by the owner (Block 343), system 100 waits for the owner to finalizes the lease (Block 523), and receives a message from the owner as in Block 345, that the deal is final (Block 524), and the bid process ends (Block 525).

If the bid was a SecureNow bid and it was accepted at Block 514, the flow proceeds to block 519, where the lease is awarded.

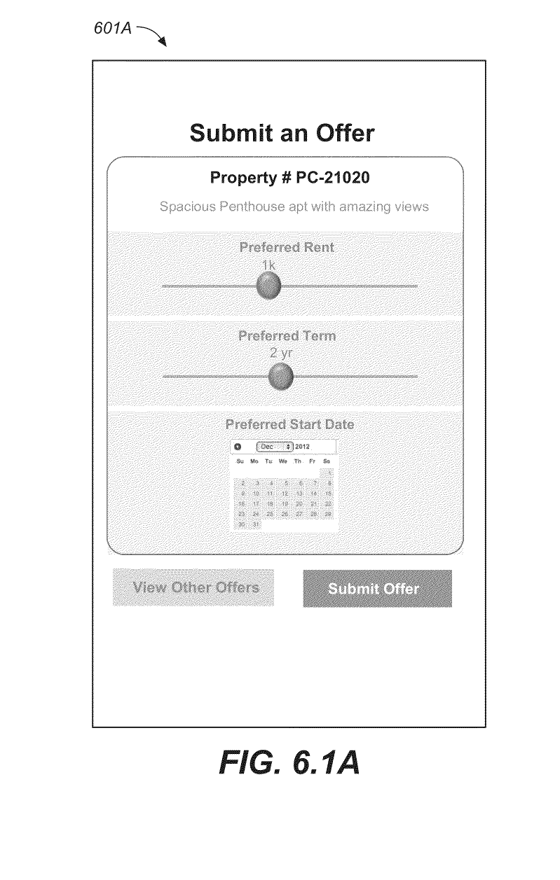

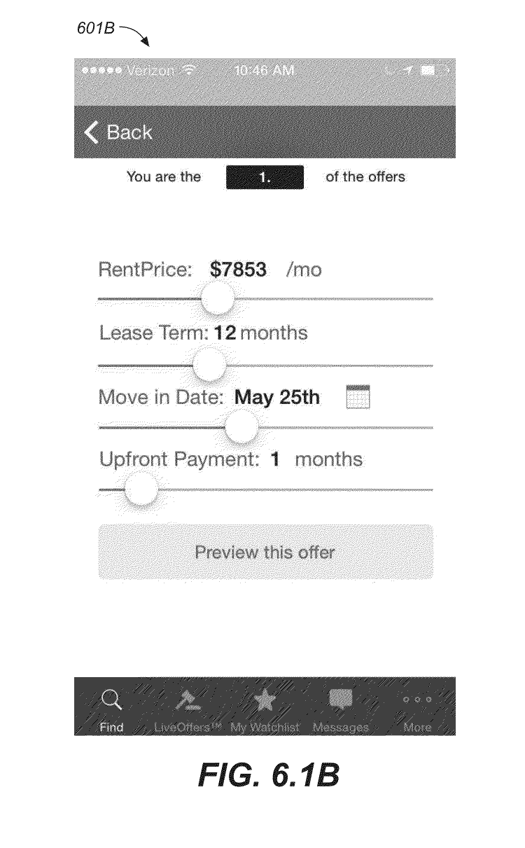

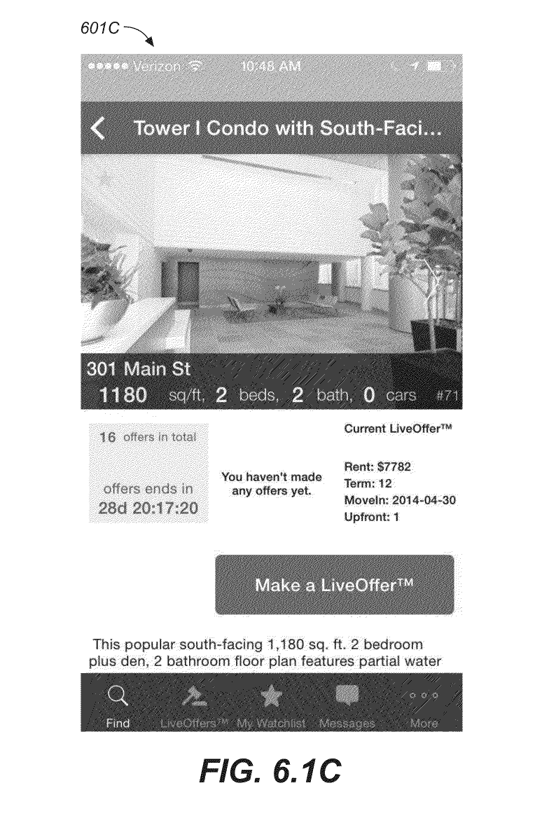

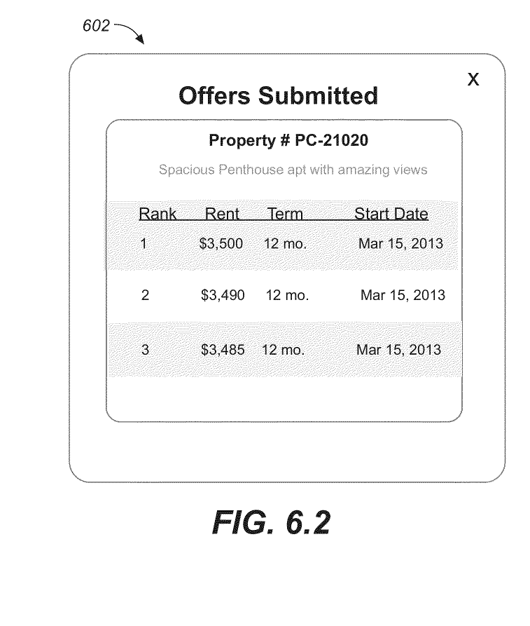

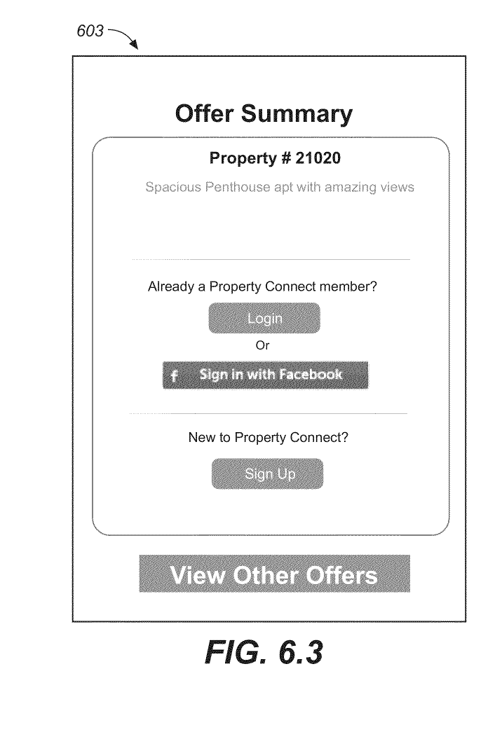

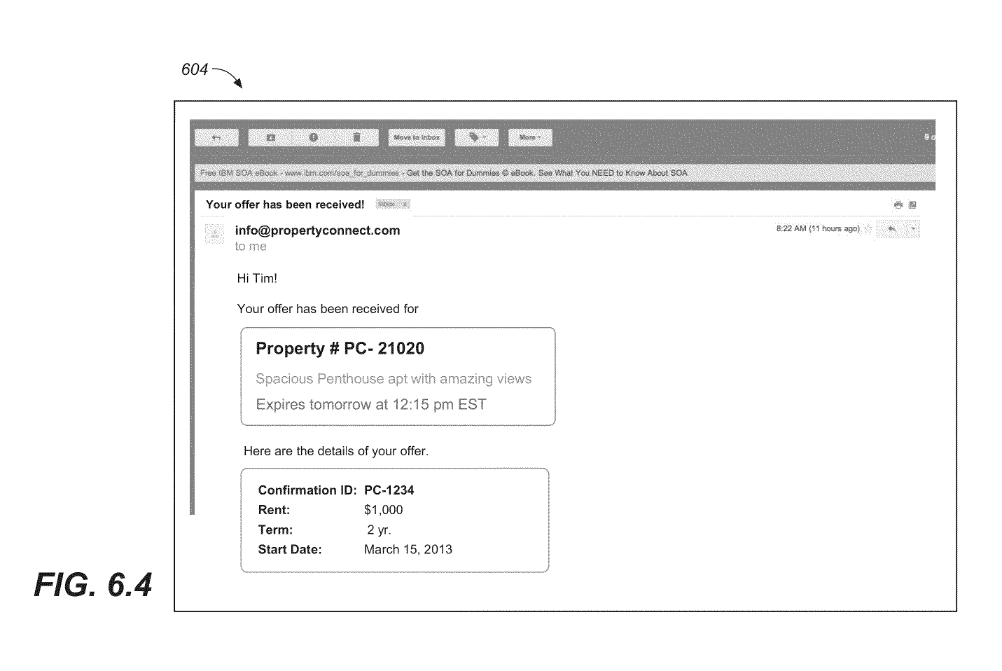

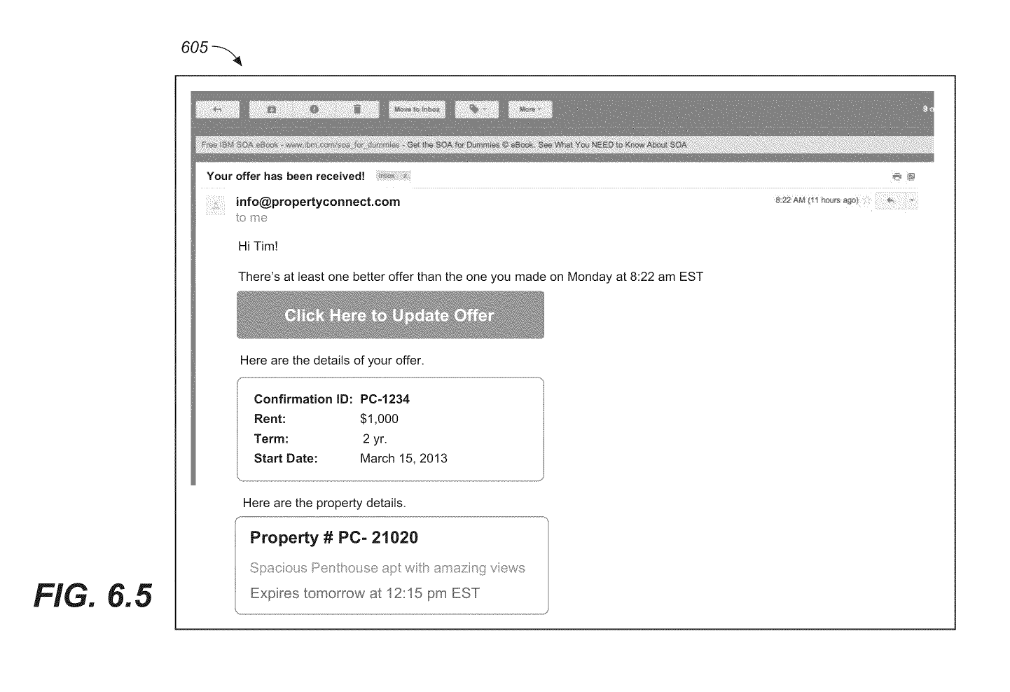

FIGS. 6.1A, 6.1B, 6.1C, 6.2, 6.3, 6.4 and 6.5 illustrate screen shots of another embodiment of the applicant's use of system 100, which may be generally similar to that shown in flowchart 500. The screenshots are generated by platform 100, such as server 110, and may provide on display 137 to an applicant so that they may input information about property to be leased, including a property description and preferred lease terms.

In one embodiment, an applicant is provided with a display as shown in the screen shot 601A of FIG. 6.1A. This may occur as a result of the applicant following a link provided by a social media cite, e-mail, or message, for example, which permits them to submit an offer, and which generally corresponds to Block 507 and 512. Specifically, the applicant is provided with three inputs: a rent (R), a term (T), and a start (or move-in) date (Date). Alternatively, the display having screen shot 601A may also include an input for an upfront payment, as was discussed previously.

In one embodiment, some numeric inputs are provided via a “slider” as shown for the rent and term. Initially the three inputs are set at the preferred values of asking rent (R_ask), preferred term (T_ask), and earliest move-in date (Date_ask), where provided by the owner as described above. In certain embodiments, the platform 100 may limit the range of acceptable offers. Thus, for example, platform 100 may limit the rent offer to be greater than one half the asking rent.

In other embodiments, optional terms provided by the owner may limit the acceptable offer. Thus, for example, if the owner has entered Min-Max optional terms, platform 100 uses values of T_min, R_min, T_max, and R_max to limit the input. Thus, for example, the applicant will be constrained to submit a term that is between T_min and T_max, a rent greater than the lowest of R_ask, R_min, and R_max (which would most likely be R_max), and a move-in date that is no later than the Latest Move-in Date.

In one embodiment, the term offer is limited to be between T_min and T_max. In another embodiment, the rent offer is limited to be greater than R_max (The rent for the maximum term). In yet another embodiment the move-in date is limited to be no later than the Latest Move-in Date.

In one embodiment, the display of screenshot 601A is interactive. As the applicant moves the rent or term inputs, the range of acceptable input for the other input changes. Thus, for example and without limitation, if the applicant moves the term input from T_ask to T_min, the rent input may be limited to be greater than R_min (the minimum rent corresponding to the minimum term). If the applicant moves the term input from T_ask to T_max, the rent input may be limited to be greater than R_max (the minimum rent corresponding to the maximum term). If the applicant moves the rent input from R_ask to R_min, the term input is limited to be greater than T_min (the minimum term corresponding to the minimum rent). If the applicant moves the rent input from R_ask to R_max, the term input is limited to be greater than T_max (the minimum term corresponding to the maximum rent).

The applicant may, from screen shot 601A, move the sliders or adjust the date as they wish, and select “Submit Offer.”

In another embodiment, an applicant is provided with a display as shown in the screen shot 601B of FIG. 6.1B, which, in addition to inputs for rent, lease term, move in date, and upfront payment, also includes an indication of the ranking of the offer prior to submission. Thus, for example system 100 may rank the applicant's proposed bid (that is, the bid prior to being placed) with all accepted bids and inform the applicant of how well the bid would be received, prior to placing the bid. The ranking may be according the ranking algorithm described herein, or by another algorithm that may be generally similar to that of Block 335. Thus, for example, the display may provide an indication of the ranking of their bid, such as “You are the 1 of the offers,” as shown in screen shot 601B, indicating that the selected term values, if submitted, would place the applicant in a number one position. The applicant may thus have an indication of the bidding process before the offer is submitted, and may adjust the bid accordingly, if they so wish. It will be appreciated that providing notification to the bidder before placing the bid may also be used in other systems or methods, such as those that accept a single criteria, such as system or method where an auction takes place by placing only a single bid criteria, such as price.

After an applicant submits a bid, platform 100 may also provide screen shot 602 of FIG. 6.2, which shows a ranking of submitted offers as, for example, determined in Block 335. Screen shot 602 allows the tenant to view the bidding process and their ranked position.

In another embodiment, an applicant is provided with a display as shown in the screen shot 601C of FIG. 6.1C, which, in addition to the information discussed in screen shots 601A and 601B, includes an indication of the total number of pending offers, and an end date for the offering period.

If the applicant is not already logged into platform 100, the screen shot 603 of FIG. 6.3 is provided to prompt the applicant for login information before proceeding. In one embodiment, the minimum amount of information required to login is provided by logging in through a social media cite that the applicant has previously signed into. In another embodiment the minimum amount of information required to login is a user name, password, and e-mail address. Other information that may be required or which may be optional is the applicants first and last name, employment information, such as which industry they work in, and whether the applicant is a tenant or is the tenant profile of an owner or agent. In certain embodiments, platform 100 stores information provided to an application. In one embodiment, platform 100 prompts the applicant with application information found on standard forms, such as the form provided by the California Association of Realtors. In certain other embodiments, the applicant information is stored in platform 100 so that the information need be entered only once, or may update the information as necessary.

In certain embodiments, platform 100 sends applicants e-mail notifications confirming offer submissions and/or changes in the rank offer. FIG. 6.4 is a screen shot 604 showing the e-mail inbox of applicant having a submission confirmation e-mail, and FIG. 6.5 is a screen shot 605 showing the e-mail inbox of applicant having an offer rank notification e-mail.

In certain embodiments, whenever the owner, or in some circumstances platform 100 changes the ranking of offers, all applicants are provided with an indication of the change to allow them to submit new offers.

In certain other embodiments, a screen shot similar to screen shot 601 also includes SecureNow button, and includes the information previously provided by the owner and/or tenant. If the applicant selects the SecureNow button, then the applicants offer is changed to match the SecureNow criteria, the owner is notified. In certain embodiments, offers are accepted until the SecureNow offer is approved. In addition or alternatively, the SecureNow bid may be given priority by an action of the owner, even of higher offers come in after the SN has been submitted.

In certain other embodiments, the method automates the offer submission process. Thus, for example, an applicant may follow steps to create a “Budget,” which sets a maximum rent, given the other selected criteria (such as term and move-in date), that the applicant is willing to submit. Platform 100 will automatically increase the rent offer by some set or adjustable amount (say, for example by $5) each time the applicant is outbid. In this way the applicant can place offers without constantly following the bidding process and will not go over budget.

In certain other embodiments, an applicant may attempt to obtain leases on more than one property by placing an offer on two or more one property. Additionally, the applicant may set a “Budget” for each property and thus may automatically bid on several properties at once.

One embodiment of each of the methods described herein is in the form of a computer program that executes on a processing system, e.g., a one or more processors that are part of a system or platform. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

I claim:

1. A method for leasing property using a computing system having a server, said method comprising the steps of:
providing preferred values for at least two lease criteria to the server;
accepting bids from one or more applicants, where each bid includes a bid value for each of the at least two lease criteria, and were said accepting includes providing the bid values for storage on a server;
receiving a ranking of the one or more applicants based on the preferred values and the bid values accepted for each applicant; and
awarding a lease to the acceptable applicant based on the received ranking.

2. The method of claim 1, where the ranking is an indication of the most acceptable applicant.

3. The method of claim 1, where the ranking is a numerical ranking of at least two of the two or more applicants.

4. The method of claim 1, where the preferred values includes a range of values for at least one of the at least two lease criteria.

5. The method of claim 4, where the range of values is a minimum or a maximum value.

6. The method of claim 5, where the range of values a minimum and a maximum value.

7. The method of claim 1, where the at least two criteria include at least one of a rent, a move in date, or a lease term.

8. The method of claim 1, where the at least two criteria includes an upfront payment.

9. The method of claim 1, where the preferred values are first preferred values, and further comprising
providing second preferred values for at least two lease criteria to the server; and
where said awarding awards the lease to the first applicant that provides bid values equal to the second preferred values.

10. An apparatus for leasing property, said apparatus comprising a server programmed to:
accept preferred values for at least two lease criteria;
accept bids from one or more applicants, where each bid includes a bid value for each of the at least two lease criteria;
provide a ranking of the one or more applicants based on the preferred values and the bid values accepted for each applicant on a display; and
award a lease to the acceptable applicant based on said ranking.

11. The apparatus of claim 10, where the ranking is an indication of the most acceptable applicant.

12. The apparatus of claim 10, where the ranking is a numerical ranking of at least two of the two or more applicants.

13. The apparatus of claim 10, where the preferred values includes a range of values for at least one of the at least two lease criteria.

14. The apparatus of claim 13, where the range of values is a minimum or a maximum value.

15. The apparatus of claim 14, where the range of values a minimum and a maximum value.

16. The apparatus of claim 10, where the at least two criteria include at least one of a rent, a move in date, or a lease term.

17. The apparatus of claim 10, where the at least two criteria includes an upfront payment.

18. The apparatus of claim 10, where the preferred values are first preferred values, and where said server is further programmed to:
accept second preferred values for at least two lease criteria to the server; and
award the lease to the first applicant having bid values accepted by the server that are equal to the second preferred values.

19. A method for leasing property using a computing system having a server, said method comprising the steps of:
accepting bids from one or more applicants including a first applicant and one or more additional applicants, where each bid includes a bid value for each of the at least two lease criteria, where each of the at least two lease criteria has a preferred value, and were said accepting includes providing the bid values for storage on a server;
determining a ranking of the one or more applicants based on the preferred values and the bid values accepted for each of the one or more applicants; and
providing the first applicant with an indication of the ranking of the first applicant.

20. The method of claim 19, where the accepting includes accepting changes in the bid from the first applicant, and where the providing provides the first applicant with an indication of the ranking of the first applicant with respect to the one or more applicants in response to the accepted changes in the bid from the first applicant.

21. The method of claim 19, where the at least two criteria include at least one of a rent, a move in date, or a lease term.

22. The method of claim 19, where the at least two criteria includes an upfront deposit.

23. An apparatus for leasing property, said apparatus comprising a server programmed to:
accept bids from one or more applicants including a first applicant and one or more additional applicants, where each bid includes a bid value for each of the at least two lease criteria, where each of the at least two lease criteria has a preferred value;
determine a ranking of the one or more applicants based on the preferred values and the bid values accepted for each of the one or more applicants; and
provide the first applicant with an indication of the ranking of the first applicant on a display.

24. The apparatus of claim 23, where the accepted bid is a subsequent bid from the first applicant, and where the server is programmed to provide the first applicant with an indication of the ranking of the first applicant with respect to the one or more applicants in response to said subsequent bid from the first applicant.

25. The apparatus of claim 23, where the at least two criteria include at least one of a rent, a move in date, or a lease term.

26. The apparatus of claim 19, where the at least two criteria includes an upfront deposit.

27. A method for using a computing system having a server to allow an applicant to determine their ranking prior to submitting a bid for leasing property, said method comprising the steps of:
accepting a proposed bid from a first applicant and a submitted bid from a second applicant, where the proposed bid and the submitted bid each include a bid value for each of the at least two lease criteria, where each of the at least two lease criteria has a preferred value, and were said accepting includes providing the proposed bid and the submitted bid for storage on a server;
determining a ranking of the first applicant based on the proposed bid of the first applicant and the submitted bid of the second applicant; and
providing the first applicant with an indication of the ranking of the first applicant.

28. The method of claim 27, where said second applicant is two or more second applicants.

29. The method of claim 27, further comprising accepting the proposed bid of the first applicant as a submitted bid of the first applicant.

30. The method of claim 27, where the at least two criteria include at least one of a rent, a move in date, or a lease term.

31. The method of claim 27, where the at least two criteria includes an upfront payment.

32. An apparatus to allow an applicant for a property to determine their ranking prior to submitting a bid for leasing property, said apparatus comprising a server programmed to:
accept a proposed bid from a first applicant and a submitted bid from a second applicant, where the proposed bid and the submitted bid each include a bid value for each of the at least two lease criteria, where each of the at least two lease criteria has a preferred value;
determine a ranking of the first applicant based on the proposed bid of the first applicant and the submitted bid of the second applicant; and
provide the first applicant with an indication of the ranking of the first applicant on a display.

33. The method of claim 32, where said second applicant is two or more second applicants.

34. The method of claim 32, where said server is programmed to accept the proposed bid of the first applicant as a submitted bid of the first applicant.

35. The method of claim 32, where the at least two criteria include at least one of a rent, a move in date, or a lease term.

36. The method of claim 32, where the at least two criteria includes an upfront payment.
